(19) United States
(12) Patent Application Publication
(10) Pub. No.: US 2008/0000592 A1
(43) Pub. Date: Jan. 3, 2008

(54) Cord-winding device for a window blind

(76) Inventor: Tai-Long Huang, Fuhsing (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/476,740

(22) Filed: Jun. 29, 2006

(51) Int. Cl. E06B 9/30

(52) U.S. Cl. 160/170

(57) ABSTRACT

A cord-winding device for winding of cords of a window blind includes first and second reel members adapted to wind and unwind the cords, respectively, two first gears connected coaxially and respectively to the reel members for simultaneous rotation, and two torsion springs connected coaxially and respectively to the reel members for urging the reel members to rotate in a winding direction. A synchronizing wheel unit includes a second gear disposed between and meshed with the first gears, and a roller connected between the torsion springs for pulling the torsion springs against spring forces of the torsion springs. A press unit has an engaging member to engage releasably and to stop rotation of the synchronizing wheel unit.

### BACKGROUND OF THE INVENTION

1. Field of the Invention

The invention relates to a cord-winding device, more particularly to a cord-winding device for a window blind.

2. Description of the Related Art

Referring to FIGS. 1 to 3, a conventional window blind 1 includes a headrail 11, a bottom rail 15, a set of horizontal slats 12 connected between the headrail 11 and the bottom rail 15, two spaced-apart cords 13 each having a fixed end connected to the headrail 11 and a movable end opposite to the fixed end, and a cord-winding device 14 disposed in the bottom rail 15. The cords 13 interconnect the slats 12. The cord-winding device 14 includes two spaced-apart gears 142 for winding and unwinding respectively the movable ends of the cords 13, a press unit 143 including a rack gear to mesh with the gears 142, and two torsion springs 144 each having one end connected to the bottom rail 15 and another end connected to the respective gear 142.

When the press unit 143 is depressed, raising and lowering of the window blind 1 are permitted. When the window blind 1 is lowered, the movable ends of the cords 13 are unwound from the respective gears 142, and the torsion springs 144 are compressed by rotation of the respective gears 142. When the window blind 1 is raised, stored spring forces of the torsion springs 144 are released so as to restore the respective gears 142 to their original positions, and the movable ends of the cords 13 are wound around the respective gears 142. When a desired length of the window blind 1 is reached, the press unit 143 is released so that the rack gear 1431 meshes with the gears 142, thereby fixing the lengths of the cords 13.

Although the aforementioned conventional cord-winding device 14 can achieve its intended purpose, it is not provided with a synchronizing wheel unit that functions to ensure simultaneous rotation of the gears 142 and thereby make uniform the lengths of the cords 13 wound around the respective gears 142. Hence, when the window blind 1 is lowered, opposite sides of the slats 12 and of the bottom rail 15 may be lowered by differing amounts, as shown in FIG. 1.

### SUMMARY OF THE INVENTION

Therefore, the object of the present invention is to provide a cord-winding device for a window blind that has a good positioning effect and that is capable of overcoming the aforementioned drawbacks of the prior art.

According to this invention, a cord-winding device for winding of cords of a window blind comprises first and second reel members adapted to wind and unwind the cords, respectively, two first gears connected coaxially and respectively to the first and second reel members for simultaneous rotation, two torsion springs connected coaxially and respectively to the first and second reel members for urging the first and second reel members to rotate in a winding direction, a synchronizing wheel unit, and a press unit. The synchronizing wheel unit includes a second gear disposed between and meshed with the first gears, and a roller connected between the torsion springs for pulling the torsion springs against spring forces of the torsion springs. The press unit has an engaging member to engage releasably the synchronizing wheel unit and to stop rotation of the synchronizing wheel unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional window blind incorporating a conventional cord-winding device;

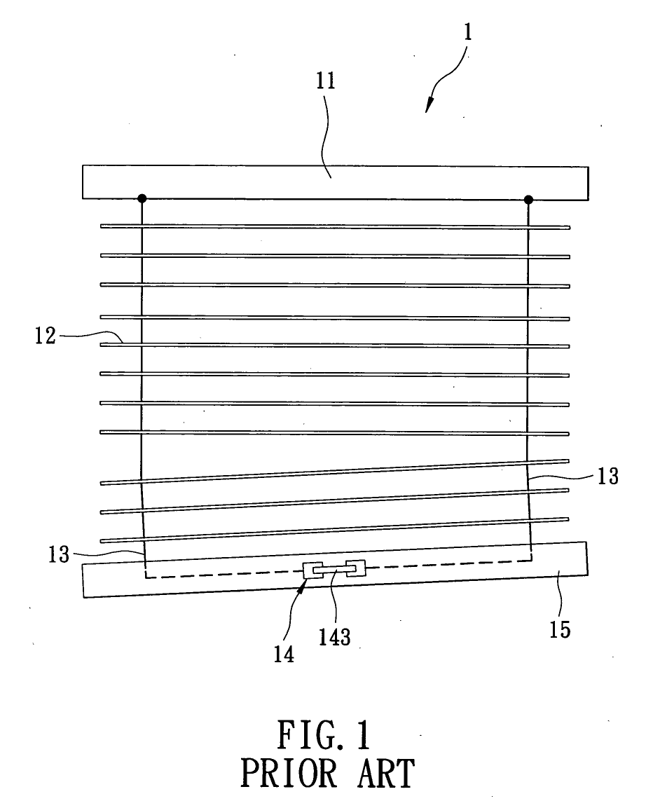

FIG. 2 is an enlarged schematic view of the conventional cord-winding device, illustrating a rack gear and two gears in a disengaged state;

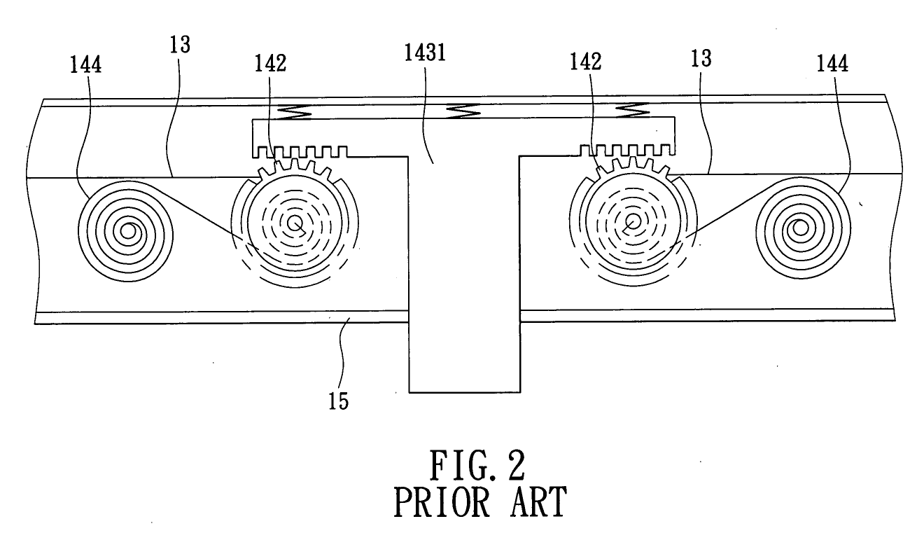

FIG. 3 is a view similar to FIG. 2, but with the rack gear and the gears in an engaged state;

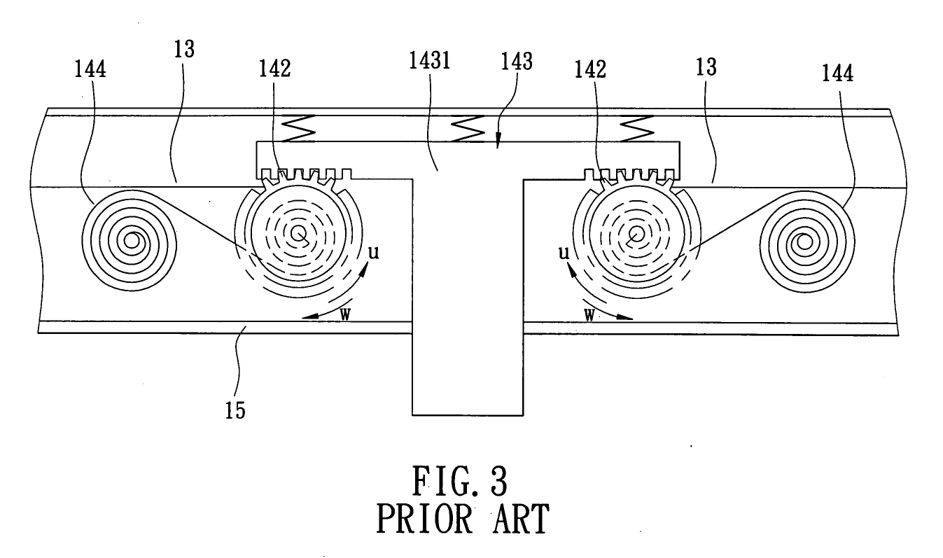

FIG. 4 is a perspective view of a window blind that incorporates the preferred embodiment of a cord-winding device of the present invention;

FIG. 5 is an exploded perspective view of the preferred embodiment;

FIG. 6 is a schematic bottom view of the preferred embodiment in an assembled state;

FIG. 7 is a view similar to FIG. 6, but with a press unit and a third gear in an engaged state;

FIG. 8 is a front schematic view of the preferred embodiment, illustrating first and second torsion springs in an uncompressed state; and

FIG. 9 is a view similar to FIG. 8, but with the first and second torsion springs in a compressed state.

### DETAILED DESCRIPTION OF THE PREFERRED EMBODIMENT

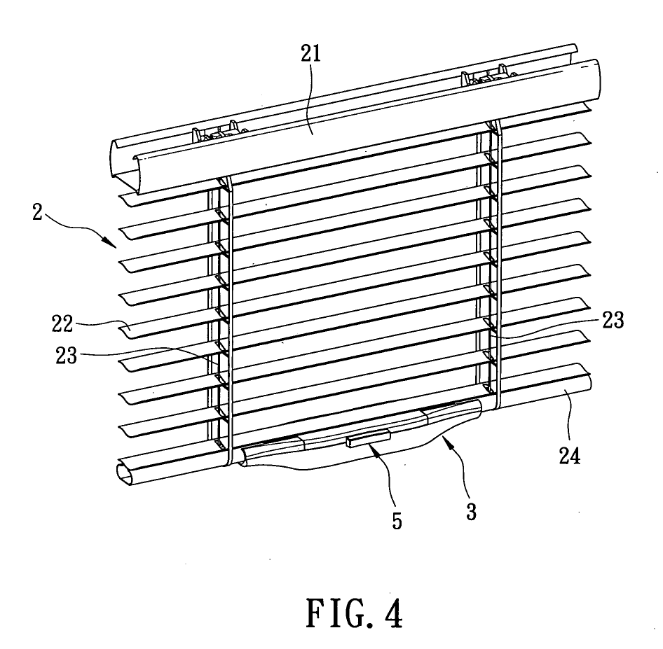

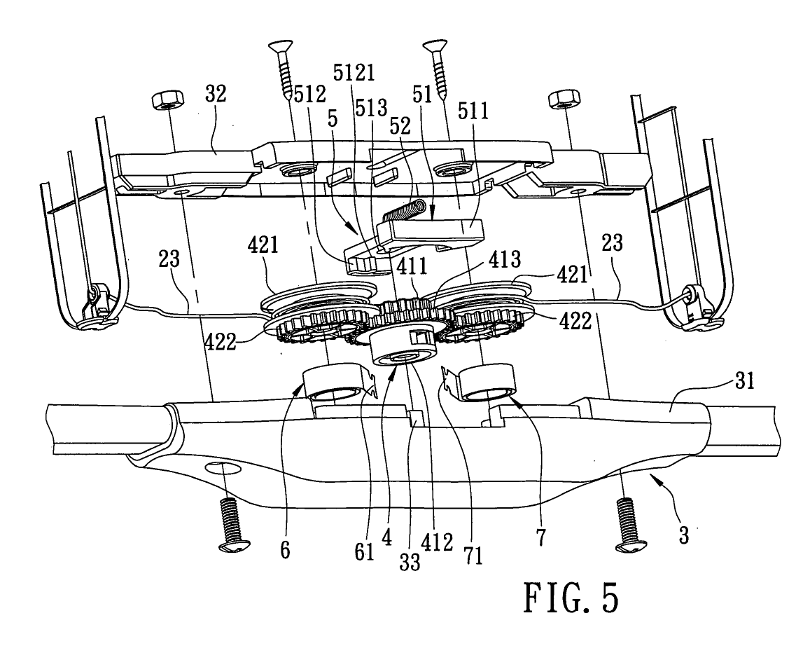

Referring to FIGS. 4 to 9, the preferred embodiment of a cord-winding device according to the present invention is adapted to wind cords of a window blind 2. The window blind 2 has a headrail 21, a bottom rail 24, a set of horizontal slats 22 connected between the headrail 21 and the bottom rail 24, and two spaced-apart cords 23 interconnecting the slats 22. Each of the cords 23 has a fixed end connected to the headrail 21 in a conventional manner, and a movable end opposite to the fixed end.

The cord-winding device of the present invention comprises a hollow fixed seat 3, first and second reel members 421, two first gears 422, two torsion springs 6, 7, a synchronizing wheel unit 4, and a press unit 5.

The fixed seat 3 is provided on the bottom rail 24, and includes a bottom casing 31, a top cover 32 screwed to the bottom casing 31 and cooperating with the same to define a chamber (not shown), and two spaced-apart second shafts 34 formed on the bottom casing 31 and located within the chamber.

The first and second reel members 421 are sleeved rotatably and respectively on the second shafts 34, and are adapted to wind and unwind the movable ends of the cords 23, respectively. The first and second reel members 421 are identical in size.

The first gears 422 are sleeved rotatably and respectively on the second shafts 34, and are adhered coaxially and respectively to the first and second reel members 421 for simultaneous rotation. The first gears 422 are identical in size.

The synchronizing wheel unit 4 includes a roller 412, a second gear 413, a third gear 411, and a first shaft 33 formed on the bottom casing 31 between the two second shafts 34 and located within the chamber. The roller 412 and the second and third gears 413, 411 are sleeved coaxially and rotatably on the first shaft 33. The second gear 413 is disposed between and meshed with the first gears 422.

The press unit 5 is mounted on the fixed seat 3 between the synchronizing wheel unit 4 and the top cover 32. The press unit 5 includes a press plate 51 and a compression spring 52. The press plate 51 has a press end 511, an engaging end opposite to the press end 511 and having an engaging member 512, and an elongated through hole 513 formed between the press end 511 and the engaging end. The engaging member 512 of the press plate 51 is provided with a tongue 5121 to engage releasably the third gear 411 of the synchronizing wheel unit 4 and to stop rotation of the synchronizing wheel unit 4. The first shaft 33 extends through the through hole 513. The compression spring 52 is disposed in the through hole 513, and has two opposite ends abutting respectively against the first shaft 33 and one edge of the press plate 51 defining the through hole 513.

Each of the torsion springs 6, 7 is wound around the respective second shaft 34, and has one end 61, 71 connected to the roller 412 so that the roller 412 can pull the torsion springs 6, 7 against spring forces of the torsion springs 6, 7. The torsion springs 6, 7 are therefore connected coaxially and respectively to the first and second reel members 421 for urging the first and second reel members 421 to rotate in a winding direction. Each torsion spring 6, 7 is located between one of the first gears 422 and the bottom casing 31.

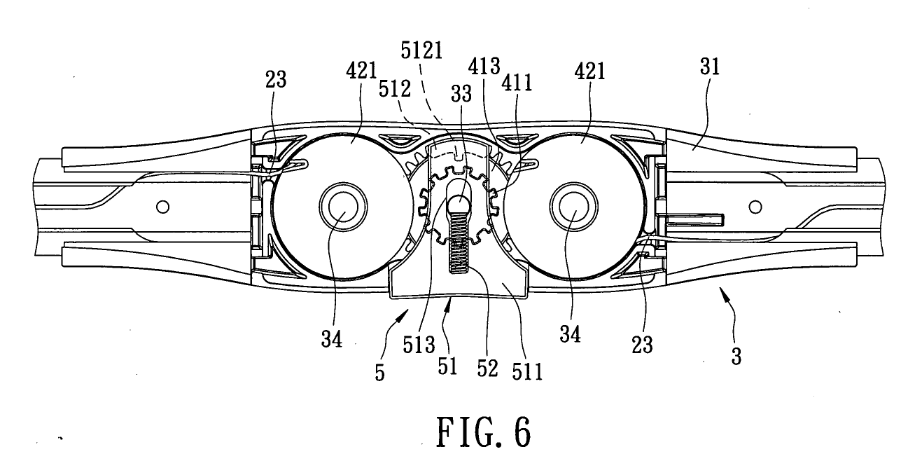

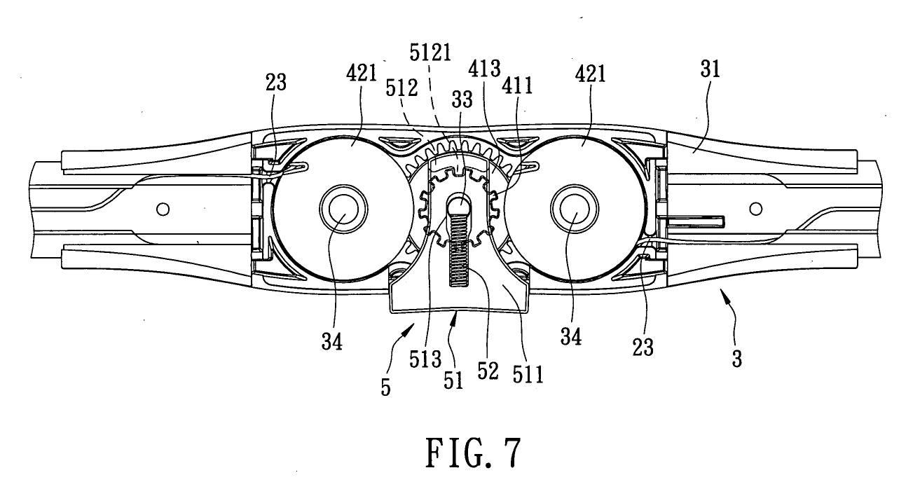

When the press unit 51 is depressed, the tongue 5121 of the engaging member 512 of the press plate 51 is moved away from the third gear 411, as best shown in FIG. 6. As such, the window blind 2 can be raised and lowered. At this time, the compression spring 52 is in a compressed state. When the press plate 51 is released, the tongue 5121 of the engaging member 512 is biased by a restoring force of the compression spring 52 to move toward the third gear 411 so as to mesh with and engage the same, as best shown in FIG. 7. As such, rotation of the third gear 411 is stopped, and the window blind 2 is maintained at a desired raised or lowered position.

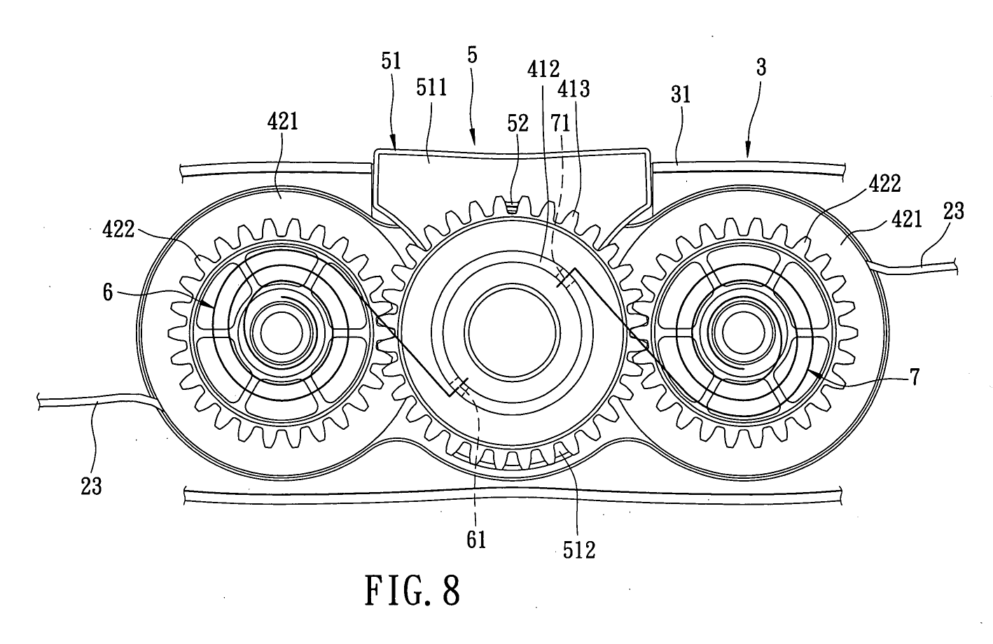

With reference to FIG. 8, in combination with FIG. 4, when the window blind 2 is raised, the first and second torsion springs 6, 7 rotate the roller 412 in a first direction relative to the fixed seat 3. At this time, the second gear 413 forces the first gears 422 to rotate in a second direction opposite to the first direction, so that the first and second reel members 421 can wind equally and respectively the cords 23.

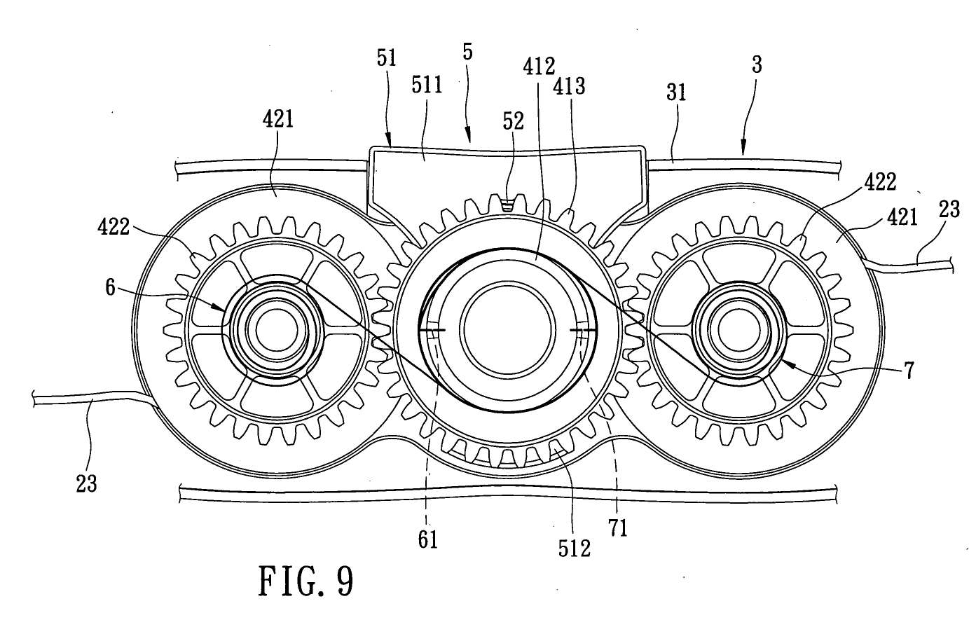

With reference to FIG. 9, in combination with FIG. 4, when the window blind 2 is lowered, the cords 23 are pulled out of the fixed seat 3 by an external force so as to cause the first and second reel members 421 to rotate in the first direction. The first gears 422 move the second gear 413 to rotate in the second direction at this time. Through rotation of the roller 412, the torsion springs 6, 7 are compressed. The second gear 413 ensures that the first gears 422 rotate simultaneously, so that the lengths of the cords 23 drawn out of the fixed seat 3 are equal.

With reference to FIG. 7, in combination with FIG. 4, when a desired length of the window blind 2 is obtained, the press plate 51 is released so as to permit the compression spring 52 to bias the tongue 5121 of the engaging member 512 toward the third gear 411 to mesh with and engage the same, so that winding and unwinding of the cords 23 can be prevented, thereby maintaining the window blind 2 at a desired raised or lowered position.

Therefore, the cord-winding device of the present invention not only has a good positioning effect, through the presence of the synchronizing wheel unit 4, the first gears 422 can be rotated simultaneously with the second gear 413 of the synchronizing wheel unit 4, so that the cords 23 can be wound and unwound by equal amounts. Hence, when the window blind 2 is raised or lowered, opposite sides of the slats 22 remain even.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A cord-winding device for winding of cords of a window blind, said cord-winding device comprising:
first and second reel members adapted to wind and unwind the cords, respectively;
two first gears connected coaxially and respectively to said first and second reel members for simultaneous rotation;
two torsion springs connected coaxially and respectively to said first and second reel members for urging said first and second reel members to rotate in a winding direction;
a synchronizing wheel unit including a second gear disposed between and meshed with said first gears, and a roller connected between said torsion springs for pulling said torsion springs against spring forces of said torsion springs; and
a press unit having an engaging member to engage releasably said synchronizing wheel unit and to stop rotation of said synchronizing wheel unit.

2. The cord-winding device of claim 1, wherein said engaging member of said press unit has a tongue.

3. The cord-winding device of claim 2, wherein said synchronizing wheel unit further includes a third gear coaxial with said second gear and said roller and engageable with said tongue, and a first shaft extending through said roller, said second gear, and said third gear.

4. The cord-winding device of claim 3, wherein said press unit further includes a press plate having a press end, an engaging end opposite to said press end and provided with said tongue, an elongated through hole formed between said press end and said engaging end, and a compression spring, said first shaft of said synchronizing wheel unit extending through said through hole, said compression spring being disposed in said through hole and having two opposite ends abutting respectively against said shaft and one edge of said press plate defining said through hole.

5. The cord-winding device of claim 3, further comprising two second shafts disposed on two opposite sides of said first shaft and each extending through one of said first and second reel members and one of said first gears, each of said torsion springs being wound around a respective one of said second shafts and having one end connected to said roller.

6. The cord-winding device of claim 1, wherein said first and second reel members are identical in size, and said first gears are identical in size.
